(19) United States
(12) Patent Application Publication
(10) Pub. No.: US 2024/0178402 A1
(43) Pub. Date: May 30, 2024

(54) NEGATIVE ELECTRODE AND BATTERY EMPLOYING THE SAME

(71) Applicant: INDUSTRIAL TECHNOLOGY RESEARCH INSTITUTE, Hsinchu (TW)

(72) Inventors: Chun-Lung LI, Taoyuan City (TW); Wei-Hsin WU, Hsinchu City (TW); Chia-Chen FANG, Taipei City (TW); Deng-Tswen SHIEH, Hsinchu City (TW); Hao-Tzu HUANG, Taichung City (TW)

(73) Assignee: INDUSTRIAL TECHNOLOGY RESEARCH INSTITUTE, Hsinchu (TW)

(21) Appl. No.: 18/519,804

(22) Filed: Nov. 27, 2023

Related U.S. Application Data
(60) Provisional application No. 63/428,926, filed on Nov. 30, 2022.

(51) Int. Cl. H01M 4/62; H01M 4/13

(52) U.S. Cl. CPC H01M 4/628; H01M 4/13; H01M 2004/027

(57) ABSTRACT

A negative electrode and a battery employing the same are provided. The negative electrode includes a negative electrode active layer and a protective layer. The protective layer is disposed on the negative electrode active layer, wherein the protective layer includes a nanopowder and a binder. The nanopowder has a specific surface area of 30 m²/g to 1,000 m²/g. The nanopowder has a binding energy less than or equal to −2.5 eV. The weight ratio of the nanopowder to the binder is from 51:49 to 99:1. The nanopowder is a compound having a structure represented by Formula (I)

MᵢXⱼ Formula (I)

wherein M is Al, Mg, Zr, Zn, or Si, and X is O or N; i is 1, 2 or 3, and j is 1, 2, 3 or 4.

### CROSS REFERENCE TO RELATED APPLICATIONS

This application claims priority to U.S. Provisional Application Ser. No. 63/428,926, filed on Nov. 30, 2022, the entirety of which is incorporated by reference herein.

### TECHNICAL FIELD

The disclosure relates to a negative electrode and a battery employing the same.

### BACKGROUND

Lithium-ion secondary batteries are mainstream commercial products, and they are presently being developed to be light-weight, low-volume, and safer, and to have a higher energy capacity and a longer cycle life. In conventional liquid electrolyte lithium-ion batteries, the energy storage cost per unit is high due to the low gravimetric energy density and the limited cycle life. However, unilaterally increasing the energy density of batteries can easily induce serial safety problems in electrochemical batteries, such as liquid leakage, battery swelling, heating, fuming, burning, explosion, and the like.

Dendrite growth is a phenomenon that occurs during battery charging, whereby active materials, usually metals such as zinc or lithium, are reduced from their oxidized state and deposited onto negative electrode. Depending on the charging conditions, the metal may be deposited a dendritic form, and has the potential to penetrate the separator and then short-circuit the cell, resulting in an explosion which is known as thermal runaway.

Therefore, a novel design and structure of a negative electrode used in the lithium battery is called for to solve the aforementioned problems.

### SUMMARY

According to embodiments of the disclosure, the disclosure provides a negative electrode. The negative electrode includes a negative electrode active layer and a protective layer. The protective layer is disposed on the negative electrode active layer, wherein the protective layer includes a nanopowder and a binder. The nanopowder has a specific surface area of 30 m²/g to 1,000 m²/g. The nanopowder has a binding energy less than or equal to −2.5 eV. The weight ratio of the nanopowder to the binder is from 51:49 to 99:1. The nanopowder is a compound having a structure represented by Formula (I)

MᵢXⱼ Formula (I)

wherein M is Al, Mg, Zr, Zn, or Si, and X is O or N; i is 1, 2 or 3, and j is 1, 2, 3 or 4.

According to embodiments of the disclosure, the disclosure also provides a battery. The battery includes the negative electrode of the disclosure, a separator and a positive electrode, wherein the negative electrode is separated from the positive electrode via the separator.

### BRIEF DESCRIPTION OF THE DRAWINGS

The present invention can be more fully understood by reading the subsequent detailed description and examples with references made to the accompanying drawings, wherein:

FIG. 1 is a cross-sectional view of the negative electrode used in the battery according to embodiments of the disclosure.

FIG. 2 is a cross-sectional view of the negative electrode used in the battery according to another embodiment of the disclosure.

FIG. 3 is a schematic view of the battery according to embodiments of the disclosure.

FIG. 4 is a graph plotting the polarization voltage against charging/discharging cycle of the batteries of Example 5, Comparative Example 7, Comparative Example 8 and Comparative Example 9.

FIG. 5 is a graph plotting the polarization voltage against charging/discharging cycle of the batteries of Example 6, Example 7, Comparative Example 10 and Comparative Example 11.

FIG. 6 is a graph plotting the polarization voltage against charging/discharging cycle of the batteries of Example 5, Comparative Example 12 and Comparative Example 13.

FIG. 7 is a graph plotting the polarization voltage against charging/discharging cycle of the batteries of Example 8, Comparative Example 14 and Comparative Example 15.

FIG. 8 is a graph plotting the polarization voltage against charging/discharging cycle of the batteries of Example 6, Comparative Example 16 and Comparative Example 17.

### DETAILED DESCRIPTION

The negative electrode and battery employing the same of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

It should be noted that the elements or devices in the drawings of the disclosure may be present in any form or configuration known to those skilled in the art. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The drawings described are only schematic and are non-limiting. In the drawings, the size, shape, or thickness of some of the elements may be exaggerated and not drawn on scale for illustrative purposes. The dimensions and the relative dimensions do not correspond to actual location to practice of the disclosure. The disclosure will be described with respect to particular embodiments and with reference to certain drawings but the disclosure is not limited thereto.

The disclosure provides a negative electrode (such as negative electrode used in lithium battery) and a battery employing the same (such as lithium battery). According to embodiments of the disclosure, the negative electrode of the disclosure includes a negative electrode active layer and a protective layer, wherein the protective layer can include a specific nanopowder and a specific binder. By means of the specific ratio of nanopowder to binder, a uniform ion diffusion pathway can be constructed during the charging/discharging process, thereby achieving the purpose of enhancing the uniformity of ion concentration and increasing interfacial energy. Due to the protective layer made from the nanopowder having high specific surface area (such as nanoscale inorganic powder) and the specific binder (such as a polymer with a high dielectric coefficient and low surface energy), the surface smoothness of the negative electrode (such as metal negative electrode) during the charging/discharging process can be enhanced and the formation of metal dendrites can be mitigated and inhibited, thereby improving the performance and extending the cycle life of the battery (such as lithium battery).

According to embodiments of the disclosure, the nanopowder (such as inorganic ceramic powder) used in the protective layer may further have a specific binding energy and a specific particle size. Therefore, the interaction between liquid electrolyte and lithium-ion is reduced via the solvation to form a high-quality solid electrolyte interface (SEI). In addition, since the nanopowder used in the protective layer is inorganic material, the protective layer exhibits high mechanical strength due to the high rigidity of nanopowder, thereby inhibiting the dendrite growth.

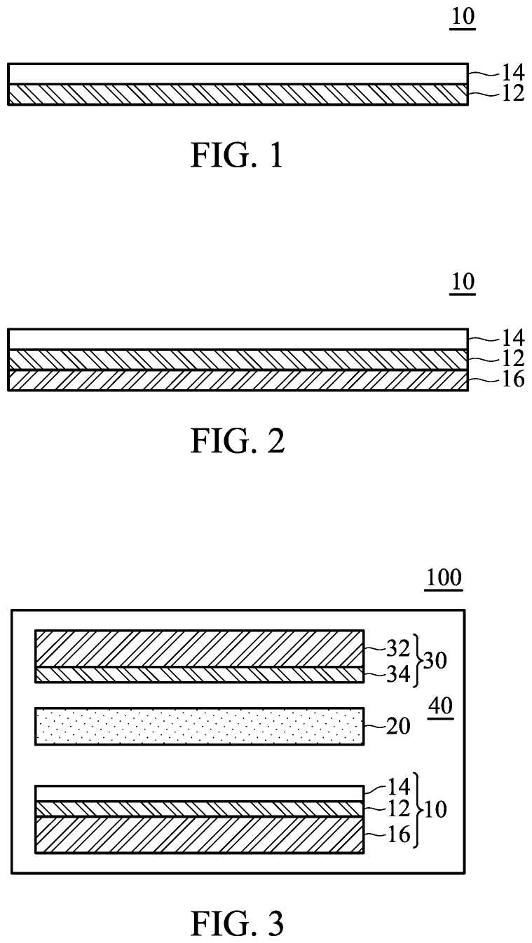

According to embodiments of the disclosure, the disclosure provides a negative electrode which serves as the negative electrode of battery (such as negative electrode of a lithium battery). According to embodiments of the disclosure, as shown in FIG. 1, the negative electrode of the disclosure 10 can include a negative electrode active layer 12 and a protective layer 14. The protective layer 14 may be disposed on the negative electrode active layer 12, wherein the protective layer 14 includes a nanopowder and a binder.

According to embodiments of the disclosure, the nanopowder may have a specific surface area of about 30 m²/g to 1,000 m²/g, such as about 50 m²/g, 100 m²/g, 200 m²/g, 300 m²/g, 400 m²/g, 500 m²/g, 600 m²/g, 700 m²/g, 800 m²/g, or 900 m²/g. According to embodiments of the disclosure, the binding energy of the nanopowder may be less than or equal to −2.5 eV. According to embodiments of the disclosure, the binding energy of the nanopowder may be about −10.0 eV to −2.5 eV, such as about −9.5 eV, −9.0 eV, −8.5 eV, −8.0 eV, −7.5 eV, −7.0 eV, −6.5 eV, −6.0 eV, −5.5 eV, −5.0 eV, −4.5 eV, −4.0 eV, −3.5 eV, or −3.0 eV. Herein, the specific surface area (BET) is determined by the nitrogen adsorption-desorption method with a surface area analyzer (ASAP2020, Micromeritics); and, the binding energy of the nanopowder of the disclosure means the binding energy (ΔE) between nanopowder and lithium. The binding energy between nanopowder and lithium (ΔE) of the disclosure is determined by the following equation: ΔE=E_{C-Li}-E_{C}-E_{Li}, wherein E_{C-Li} represents the free energy of the binding reaction between nanopowder and lithium, E_{C} represents the free energy of the nanopowder, and E_{Li} represents the free energy of lithium (OK, under vacuum). According to embodiments of the disclosure, the weight ratio of the nanopowder to the binder may be from about 51: 49 to 99: 1, such as about 55: 45, 60: 40, 65: 35, 70: 30, 75: 25, 80: 20, 85: 15, 90: 10, 95: 5, or 97: 3. According to embodiments of the disclosure, when the specific surface area of the nanopowder used in the protective layer of the disclosure is within a range from about 30 m²/g to 1,000 m²/g, the binding energy (ΔE) between nanopowder and lithium is within a range from about −10.0 eV to −2.5 eV, and the weight ratio of the nanopowder to the binder is within a range from about 51: 49 to 99: 1, the formed protective layer can enhance the uniformity of ion concentration in the battery and increase the interfacial energy. Therefore, the surface smoothness of the negative electrode during the charging/discharging process can be enhanced and the formation of metal dendrites can be mitigated and inhibited, thereby improving the performance and extending the cycle life of the battery (such as lithium battery).

According to embodiments of the disclosure, the mean particle size of primary particle of inorganic powder may be about 1 nm to 300 nm, such as 10 nm, 50 nm, 100 nm, 150 nm, 200 nm, or 250 nm. Herein, according to embodiments of the disclosure, the mean primary particle size is imaged by transmission electron microscope (TEM) and then analyzed by particle size analyser (TGZ). According to embodiments of the disclosure, when the specific surface area of the nanopowder used in the protective layer of the disclosure is within a range from about 30 m²/g to 1,000 m²/g, the binding energy (AE) between nanopowder and lithium is within a range from about −10.0 eV to −2.5 eV, and the mean primary particle size of the nanopowder is within a range from about 1 nm to 300 nm, the formed protective layer can enhance the uniformity of ion concentration in the battery and increase the interfacial energy. Therefore, the surface smoothness of the negative electrode during the charging/discharging process can be enhanced and the formation of metal dendrites can be mitigated and inhibited, thereby improving the performance and extending the cycle life of the battery (such as lithium battery).

According to embodiments of the disclosure, the nanopowder may be a compound having a structure represented by Formula (I)

MᵢXⱼ Formula (I)

wherein M is aluminum, magnesium, zirconium, zinc, or silicon; X is O or N; i is 1, 2 or 3; j is 1, 2, 3, or 4. According to embodiments of the disclosure, M has a valence of a, X has an absolute valence value of b, and a/b=j/i.

According to embodiments of the disclosure, the nanopowder may be aluminum oxide, magnesium oxide, zirconium oxide, zinc oxide, silicon oxide, aluminum nitride, magnesium nitride, zirconium nitride, zinc nitride, silicon nitride, or a combination thereof. Table 1 lists the binding energy (AE) between the nanopowder and lithium of the disclosure.

TABLE 1

| nanopowder | ΔE(eV) |
|---|---|
| γ-Al₂O₃ | −2.55 |
| SiO₂ | −2.96 |
| ZrO₂ | −2.63 |
| ZnO | −3.01 |

According to embodiments of the disclosure, the dielectric coefficient of the binder used in the protective layer of the disclosure may be about 9 to 20, such as about 10, 11, 12, 13, 14, 15, 16, 17, 18, or 19. In addition, the surface energy of the binder may be about 0 mJ/m² to 38 mJ/m², such as about 2 mJ/m², 4 mJ/m², 6 mJ/m², 8 mJ/m², 10 mJ/m², 12 mJ/m², 14 mJ/m², 16 mJ/m², 18 mJ/m², 20 mJ/m², 22 mJ/m², 24 mJ/m², 26 mJ/m², 28 mJ/m², 30 mJ/m², 32 mJ/m², 34 mJ/m², or 36 mJ/m². According to embodiments of the disclosure, when the dielectric coefficient and surface energy of the binder used in the protective layer of the disclosure are within the aforementioned range, the binder, in combination with the aforementioned nanopowder, forms a protective layer that enhances the uniformity of ion concentration in the battery and improves the interfacial energy. Therefore, the surface smoothness of the negative electrode during the charging/discharging process can be enhanced and the formation of metal dendrites can be mitigated and inhibited, thereby improving the performance and extending the cycle life of the battery (such as lithium battery). According to embodiments of the disclosure, the dielectric coefficient of the binder is determined by LCR tester (Agilent E4980A) under conditions of 100 Hz. According to embodiments of the disclosure, the surface energy of the binder is determined by Owens-Wendt geometric mean.

According to embodiments of the disclosure, the used in the protective layer of the disclosure binder may be fluorine-containing polymer (fluorine-containing compound), wherein the fluorine-containing polymer may be polytetrafluoroethylene (PTFE), polyvinylidene fluoride (PVDF), perfluoroalkoxy alkane (PFA), fluorinated ethylene propylene (FEP), polyvinylidene fluoride-co-hexafluoropropen (PVDF-HFP), polyvinylene fluoride (PVF), or a combination thereof. Table 2 lists the dielectric coefficient and surface energy of the binder of the disclosure.

TABLE 2

| | dielectric | surface energy |
|---|---|---|
| | coefficient | (mJ/m²) |
| polyvinylidene fluoride | 10 | 34.8 |
| (PVDF) | | |
| fluorinated ethylene | 15.2 | 31.0 |
| propylene (FEP) | | |

According to embodiments of the disclosure, the thickness of the protective layer 14 may be about 0.01 μm to 10 μm (such as about 0.05 μm, 0.1 μm, 0.2 μm, 0.3 μm, 0.5 μm, 1 μm, 2 μm, 3 μm, 4 μm, 5 μm, 6 μm, 7 μm, 8 μm, or 9 μm).

According to embodiments of the disclosure, the protective layer may consist of the nanopowder and the binder.

According to embodiments of the disclosure, the negative electrode active layer 12 can include a negative electrode active material, wherein the negative electrode active material can include lithium metal, lithium metal alloy, or a combination thereof. According to embodiments of the disclosure, the lithium-containing metal alloy can include LiAl, LiMg, LiZn, Li₃Bi, Li₃Cd, Li₃Sb, Li₄Si, Li_{4.4}Pb, or Li_{4.4}Sn. According to embodiments of the disclosure, the negative electrode active layer 12 may consist of the negative electrode active material.

According to embodiments of the disclosure, the negative electrode active layer 12 may further include a binder. The binder can include polytetrafluoroethylene (PTFE), polyvinylidene fluoride (PVDF), poly(styrene-co-butadiene), fluorine rubber, polyurethane, polyvinylpyrrolidone, polyvinyl carbonate, polyvinyl chloride (PVC), polyacrylonitrile (PAN), polybutadiene, poly(acrylic acid) (PAA), or a combination thereof. According to embodiments of the disclosure, the negative electrode active layer 12 may consist of the negative electrode active material and the binder.

According to embodiments of the disclosure, in the negative electrode active layer 12, the negative electrode active material may has a weight percentage of about 90 wt % to 99.9 wt % (such as 91 wt %, 92 wt %, 93 wt %, 94 wt %, 95 wt %, 96 wt %, 97 wt %, 98 wt %, or 99 wt %) and the binder may have a weight percentage of about 0.1 wt % to 10 wt % (such as 1 wt %, 2 wt %, 3 wt %, 4 wt %, 5 wt %, 6 wt %, 7 wt %, 8 wt %, or 9 wt %), based on the total weight of the negative electrode active material and the binder. According to embodiments of the disclosure, in the negative electrode active layer 12, the weight ratio of the binder to the negative electrode active material may be 0.1:99.9 to 10:90 (such as 1:99, 2:98, 3: 97, 4:96, 5:95, 6:94, 7:93, 8:92, or 9:91).

According to embodiments of the disclosure, the thickness of the negative electrode active layer 12 is not limited and can be optionally modified by a person of ordinary skill in the field. For example, the thickness of the negative electrode active layer 12 may be about 1 μm to 1,000 μm (such as about 5 μm, 10 μm, 50 μm, 100 μm, 200 μm, 300 μm, 400 μm, 500 μm, 600 μm, 700 μm, 800 μm, or 900 μm).

According to embodiments of the disclosure, the method for preparing the negative electrode 10 as shown in FIG. 1 may include following steps. First, a negative electrode active layer (such as lithium foil) 12 is provided. Next, the nanopowder is dispersed in a solvent to obtain a first solution (with a solid content of 1 wt % to 30 wt %), and the binder is dispersed in a solvent to obtain a second solution (with a solid content of 1 wt % to 30 wt %). According to embodiments of the disclosure, the solvent of the first solution and the second solution may be independently dimethoxyethane (DME), 1-methyl-2-pyrrolidinone (NMP), N, N-dimethylformamide (DMF), N, N-dimethylacetamide (DMAc), pyrrolidone, N-dodecylpyrrolidone, γ-butyrolactone, or a combination thereof. Herein, the solid content means a weight percentage of the ingredients of the solution except the solvent, based on the total weight of the solution. Next, the first solution and the second solution are mixed, obtaining a protective layer slurry. Next, the protective layer slurry is coated on a surface of the negative electrode active layer 12 to form a coating via a coating process. Next, the coating is subjected to a drying process (with a process temperature of 90° C. to 180° C.), obtaining the protective layer 14. The coating process may be screen printing, spin coating, bar coating, blade coating, roller coating, solvent casting, or dip coating.

According to embodiments of the disclosure, as shown in FIG. 2, the negative electrode 10 of the disclosure can include the negative electrode active layer 12, the protective layer 14, and a negative electrode current-collecting layer 16, wherein the negative electrode active layer 12 is disposed on the negative electrode current-collecting layer 16, and the protective layer 14 is disposed on the negative electrode active layer 12.

According to embodiments of the disclosure, the thickness of the negative electrode current-collecting layer 16 is not limited and can be optionally modified by a person of ordinary skill in the field. For example, the thickness of the negative electrode current-collecting layer 16 may be about 1 μm to 100 μm (such as about 2 μm, 4 μm, 6 μm, 8 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, or 95 μm). According to embodiments of the disclosure, the negative electrode current-collecting layer 16 may be conductive carbon substrate, metal foil, or metal material with a porous structure, such as carbon cloth, carbon felt, or carbon paper, copper foil, nickel foil, aluminum foil, nickel net, copper net, molybdenum net, nickel foam, copper foam, or molybdenum foam. According to embodiments of the disclosure, the metal material with a porous structure may have a porosity about 10% to 99.9% (such as 20%, 30%, 40%, 50%, 60%, 70%, 80%, or 90%).

According to embodiments of the disclosure, the negative electrode 10 may consist of the negative electrode active layer 12 and the protective layer 14. In addition, According to embodiments of the disclosure, the negative electrode 10 may consist of the negative electrode current-collecting layer 16, negative electrode active layer 12 and protective layer 14.

According to embodiments of the disclosure, the method for preparing the negative electrode 10 of FIG. 2 can include following steps. First, a lamination of the negative electrode active layer 12 and the negative electrode current-collecting layer 16 is provided. Next, nanopowder is dispersed in a solvent (with a solid content may be 1 wt % to 30 wt %) obtaining a first solution. The binder is dispersed in a solvent (with a solid content may be 1 wt % to 30 wt %) obtaining a second solution. Next, the first solution and second solution are mixed, obtaining a protective layer slurry. Next, the protective layer slurry is coated on the surface of the negative electrode active layer 12 to form a coating via a coating process. Next, the coating is subjected to a drying process (with a temperature of 90° C. to 180° C.), obtaining the protective layer 14.

According to embodiments of the disclosure, as shown in FIG. 3, the disclosure also provides a battery 100, such as lithium battery, lithium-ion battery, or lithium metal battery. The battery 100 includes the negative electrode 10 of FIG. 2, a separator 20, and a positive electrode 30. The negative electrode 10 is separated from the positive electrode 30 via the separator 20. According to embodiments of the disclosure, the positive electrode 30 may directly contact the separator 20, and/or the negative electrode 10 may directly contact the separator 20. According to embodiments of the disclosure, the positive electrode 30 may be separated from the separator 20 by a distance, and/or the negative electrode 10 may be separated from the separator 20 by a distance.

According to embodiments of the disclosure, the battery 100 may further include an liquid electrolyte 40, and the liquid electrolyte 40 is disposed between the negative electrode 10 and the positive electrode 30. Namely, the structure stacked by the negative electrode 10, separator 20 and positive electrode 30 is immersed in the liquid electrolyte 40. Namely, the battery 100 is filled with the liquid electrolyte 40. According to some embodiments of the disclosure, the protective layer 14 of the disclosure may be disposed between the separator 20 and the negative electrode active layer 12, and the protective layer 14 of the disclosure may directly contacts the separator 20. According to embodiments of the disclosure, the battery 100 of the disclosure may consist of the negative electrode 10, the separator 20, the positive electrode 30, and the liquid electrolyte 40.

According to embodiments of the disclosure, the separator 20 may include insulating material, such as polyethylene (PE), polypropylene, (PP), polytetrafluoroethylene (PTFE), polyamide, polyvinylchloride (PVC), poly(vinylidene fluoride), polyaniline, polyimide, nonwoven fabric, polyethylene terephthalate, polystyrene (PS), cellulose, or a combination thereof. For example, the separator 20 may be PE/PP/PE multilayer composite structure. According to embodiments of the disclosure, the separator may have a porous structure. Namely, the pores of the separator are uniformly distributed among the whole separator.

According to embodiments of the disclosure, the liquid electrolyte 40 can include a solvent and a lithium salt (or lithium-containing compound). According to embodiments of the disclosure, the liquid electrolyte 40 of the disclosure is not limited and can be optionally modified by a person of ordinary skill in the field, and may be conventional liquid electrolyte used in the lithium battery. According to embodiments of the disclosure, the concentration of the lithium salt in the solvent may be about 0.8M to 1.6M, such as about 0.9M, 1.0M, 1.1M, 1.2M, 1.3M, 1.4M, or 1.5M. According to embodiments of the disclosure, the solvent may be organic solvent, such as ester solvent, ketone solvent, carbonate solvent, ether solvent, alkane solvent, amide solvent, or a combination thereof. According to embodiments of the disclosure, the solvent may be 1,2-diethoxyethane, 1,2-dimethoxyethane, 1,2-dibutoxyethane, tetrahydrofuran (THF), 2-methyl tetrahydrofuran, dimethylacetamide (DMAc), 1-methyl-2-pyrrolidinone (NMP), methyl acetate, ethyl acetate, methyl butyrate, ethyl butyrate, methyl propionate, ethyl propionate, propyl acetate (PA), γ-butyrolactone (GBL), ethylene carbonate(EC), propylene carbonate (PC), diethyl carbonate (DEC), ethylmethyl carbonate (EMC), dimethyl carbonate (DMC), vinylene carbonate, butylene carbonate, dipropyl carbonate, fluoroethylene carbonate (FEC), dimethoxyethane (DME), 1,1,2,2-tetrafluoroethyl-2,2,3,3-tetrafluoropropyl ether (TTFE), or a combination thereof. According to embodiments of the disclosure, the lithium salt may be lithium hexafluorophosphate (LiPF₆), lithium perchlorate (LiClO₄), bis(fluorosulfonyl)imide lithium (LiN(SO₂F)₂) (LiFSI), lithium difluoro(oxalato)borate (LiBF₂(C₂O₄)) (LiDFOB), lithium tetrafluoroborate (LiBF₄), lithium trifluoromethanesulfonate (LiSO₃CF₃), bis(trifluoromethane)sulfonimide lithium (LiN(SO₂CF₃)₂) (LiTFSI), lithium bis perfluoroethanesulfonimide (LiN(SO₂CF₂CF₃)₂), lithium hexafluoroarsenate (LiAsF₆), lithium Hexafluoroantimonate (LiSbF₆), lithium tetrachloroaluminate (LiAlCl₄), lithium tetrachlorogallate (LiGaCl₄), lithium nitrate (LiNO₃), tris(trifluoromethanesulfonyl)methyllithium (LiC(SO₂CF₃)₃), lithium thiocyanate hydrate (LiSCN), LiO₃SCF₂CF₃, LiC₆F₅SO₃, LiO₂CCF₃, lithiumfluorosulfonate (LiSO₃F), lithium tetrakis(pentafluorophenyl)borate (LiB(C₆H₅)₄), lithium bis(oxalato)borate (LiB(C₂O₄)₂) (LiBOB), or a combination thereof.

According to embodiments of the disclosure, the positive electrode 30 can include a positive electrode current-collecting layer 32, and a positive electrode active layer 34 disposed on the positive electrode current-collecting layer 32, wherein the positive electrode active layer 34 includes a positive electrode active material. According to embodiments of the disclosure, the positive electrode active material may be sulfur, organic sulfide, sulfur-carbon composite, metal-containing lithium oxide, metal-containing lithium sulfide, metal-containing lithium selenide, metal-containing lithium telluride, metal-containing lithium silicide, metal-containing lithium boride, or a combination thereof, wherein the metal is selected from a group consisting of aluminum, vanadium, titanium, chromium, copper, molybdenum, niobium, iron, nickel, cobalt and manganese. According to embodiments of the disclosure, the positive electrode material may be lithium-cobalt oxide, lithium-nickel oxide, lithium-manganese oxide, lithium-cobalt-manganese oxide, lithium-nickel-cobalt oxide, lithium-nickel-manganese oxide, lithium-nickel-manganese-cobalt oxide, lithium-chromium-manganese oxide, lithium-nickel-vanadium oxide, lithium-manganese-nickel oxide, lithium-cobalt-vanadium oxide, lithium-nickel-cobalt-aluminum oxide or a combination thereof.

According to embodiments of the disclosure, the lithium-nickel-manganese-cobalt oxide of the disclosure may have a structure of LiNiₓCo_{y}Mn_{z}O₂, wherein 0<x<1, 0<y<1, 0<z<1, and x+y+z=1. According to embodiments of the disclosure, lithium nickel cobalt aluminum oxide may have a chemical structure of LiNi_{0.80}Co_{0.15}Al_{0.05}O₂. According to embodiments of the disclosure, lithium cobalt oxide may have a chemical structure of LiCoO₂.

According to embodiments of the disclosure, the positive electrode active layer 34 may further include a binder. According to embodiments of the disclosure, in the positive electrode active layer 34, the weight ratio of the binder to the positive electrode active material may be 0.1:99.9 to 10:90 (such as 1:99, 2:98, 3: 97, 4:96, 5:95, 6:94, 7:93, 8:92, or 9:91). According to embodiments of the disclosure, the binder can include polyvinyl alcohol (PVA), polytetrafluoroethylene (PTFE), carboxymethyl cellulose (CMC) sodium, polyvinylidene fluoride (PVDF), poly(styrene-co-butadiene), fluorine rubber, polyurethane, polyvinylpyrrolidone, polyvinyl carbonate, polyvinyl chloride (PVC), polyacrylonitrile (PAN), polybutadiene, poly(acrylic acid) (PAA), or a combination thereof. According to embodiments of the disclosure, the positive electrode active layer 34 may further include a conductive additive, wherein conductive additive may be conductive carbon black, conductive graphite, fluorocarbon, reduced graphene, nitrogen-doped graphite, nitrogen-doped graphene, carbon fiber, carbon nanotube, or a combination thereof. According to embodiments of the disclosure, in the positive electrode active layer 34, the weight ratio of the conductive additive to the positive electrode active material may be 0.1:99.9 to 10:90 (such as 1:99, 2:98, 3: 97, 4:96, 5:95, 6:94, 7:93, 8:92, or 9:91). According to embodiments of the disclosure, the positive electrode active layer 34 may consist of the positive electrode active material and the binder. According to embodiments of the disclosure, the positive electrode active layer 34 may consist of the binder, the conductive additive and the positive electrode active material.

According to embodiments of the disclosure, the positive electrode current-collecting layer 32 may be conductive carbon substrate, metal foil, or metal material with a porous structure, such as carbon cloth, carbon felt, carbon paper, copper foil, nickel foil, aluminum foil, nickel net, copper net, molybdenum net, nickel foam, copper foam, or molybdenum foam. According to embodiments of the disclosure, the metal material with a porous structure may have a porosity about 10% to 99.9% (such as 20%, 30%, 40%, 50%, 60%, 70%, 80%, or 90%).

According to embodiments of the disclosure, the positive electrode active layer 34 of the disclosure may be disposed between the separator 20 and the positive electrode current-collecting layer 32.

According to embodiments of the disclosure, the thickness of the positive electrode active layer 34 is not limited and can be optionally modified by a person of ordinary skill in the field. For example, the thickness of the positive electrode active layer 34 may be about 1 μm to 1,000 μm (such as about 5 μm, 10 μm, 50 μm, 100 μm, 200 μm, 300 μm, 400 μm, 500 μm, 600 μm, 700 μm, 800 μm, or 900 μm). According to embodiments of the disclosure, the thickness of the positive electrode current-collecting layer 32 is not limited and can be optionally modified by a person of ordinary skill in the field. For example, the thickness of the positive electrode current-collecting layer 32 may be about 1 μm to 100 μm (such as about 5 μm, 10 μm, 20 μm, 50 μm, 60 μm, 70 μm, 80 μm, or 90 μm).

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### Preparation of Negative Electrode

### Example 1

γ-aluminum oxide nanopowder (1) (with a mean primary particle size of about 10 nm and a specific surface area of about 115 m²/g) was dispersed in dimethoxyethane (DME). After stirring, a first solution was obtained (with a solid content of about 5 wt %). Next, polyvinylidene fluoride-co-hexafluoropropen (PVDF-HFP) (commercially available from Sigma-Aldrich, having a weight average molecular weight of about 400,000) was dissolved in dimethoxyethane (DME). After stirring, a second solution was obtained (with a solid content of about 5 wt %). Next, the first solution and the second solution were mixed, and Protective layer slurry (1) was obtained after stirring for 2 hrs. In Protective layer slurry (1), the weight ratio of γ-aluminum oxide nanopowder to polyvinylidene fluoride-co-hexafluoropropen (PVDF-HFP) was 4: 1.

Next, a lamination consisting of a lithium foil and a copper foil (commercially available from Honjo Metal Co., Ltd.) (with a thickness of 60 μm) (the lithium foil served as the negative electrode active layer (with a thickness about 50 μm) and the copper foil served as the negative electrode current-collecting layer) was provided. Next, Protective layer slurry (1) was coated on the lithium foil of the lamination by blade coating, and the result was baked at 80° C. to obtain Negative electrode (1) with a protective layer (with a thickness of about 5 μm).

### Example 2

Example 2 was performed in the same manner as the battery of Example 1, except that the weight ratio of γ-aluminum oxide nanopowder to polyvinylidene fluoride-co-hexafluoropropen (PVDF-HFP) was adjusted from 4: 1 to 3:1, obtaining Negative electrode (2).

### Example 3

Example 3 was performed in the same manner as the battery of Example 1, except that the weight ratio of γ-aluminum oxide nanopowder to polyvinylidene fluoride-co-hexafluoropropen (PVDF-HFP) was adjusted from 4: 1 to 2:1, obtaining Negative electrode (3).

### Example 4

Example 4 was performed in the same manner as the battery of Example 1, except that γ-aluminum oxide nanopowder (1) was replaced with aluminum nitride nanopowder (with a mean primary particle size of about 70 nm and a specific surface area of about 50 m²/g), obtaining Negative electrode (4).

### Comparative Example 1

Comparative Example 1 was performed in the same manner as the battery of Example 1, except that γ-aluminum oxide nanopowder (1) was replaced with γ-aluminum oxide nanopowder (2) (with a mean primary particle size of about 300 nm and a specific surface area of about 5 m²/g), obtaining Negative electrode (5).

### Comparative Example 2

Comparative Example 2 was performed in the same manner as the battery of Example 1, except that γ-aluminum oxide nanopowder (1) was replaced with γ-aluminum oxide nanopowder (3) (with a mean primary particle size of about 500 nm and a specific surface area of about 5 m²/g), obtaining Negative electrode (6).

### Comparative Example 3

Comparative Example 3 was performed in the same manner as the battery of Example 1, except that γ-aluminum oxide nanopowder (1) was replaced with γ-aluminum oxide nanopowder (4) (with a mean primary particle size of about 20 nm and a specific surface area of about 15 m²/g), obtaining Negative electrode (7).

### Comparative Example 4

Comparative Example 4 was performed in the same manner as the battery of Example 1, except that γ-aluminum oxide nanopowder (1) was replaced with lithium zirconium phosphate (LZP) (with a mean primary particle size of about 61 nm and a specific surface area of about 1.5 m²/g), obtaining Negative electrode (8).

### Comparative Example 5

Comparative Example 5 was performed in the same manner as the battery of Example 1, except that γ-aluminum oxide nanopowder (1) was replaced with lithium lanthanum zirconate (LLZO) (with a mean primary particle size of about 1.7 nm and a specific surface area of about 0.2 m²/g), obtaining Negative electrode (9).

### Comparative Example 6

Comparative Example 6 was performed in the same manner as the battery of Example 1, except that γ-aluminum oxide nanopowder (1) was replaced with conductive carbon black (with a trade number of Super-P, commercially available from Timcal) (with a mean primary particle size of about 40 nm and a specific surface area of about 62 m²/g), obtaining Negative electrode (10).

### Performance of Negative Electrode (Half Battery Evaluation)

### Example 5

Negative electrode (1) of Example 1, a polypropylene (PP) separator (with a trade number of 2320, commercially available from Celgard, with a thickness about 20 μm) and a lamination (serving a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell, wherein the protective layer of the negative electrode was oriented toward the separator, and the lithium foil of the positive electrode was oriented toward the separator. Next, a liquid electrolyte (with a code of LHCE including lithium bis(fluorosulfonyl)imide (LiFSI) and a solvent (with a concentration of 1.5M), wherein the solvent was 1,2-dimethoxyethane (DME) and 1,1,2,2-tetrafluoroethyl-2,2,3,3-tetrafluoropropyl ether (TTFE)) was injected into the cell. After packaging, Battery (1) was obtained.

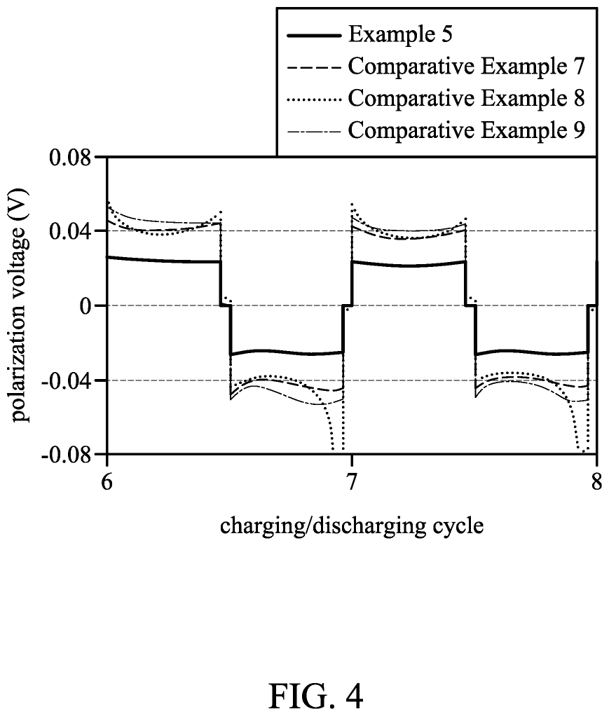

Next, the polarization voltage and the polarization voltage difference of Battery (1) were measured, as shown in FIG. 4. The method for measuring the polarization voltage was disclosed below. The battery was charged and discharged at a fixed current density of 0.5 mAcm⁻². The polarization voltage was the initial voltage during charging. The polarization voltage difference was the percentage difference between the polarization voltage and the intermediate voltage (with the intermediate voltage as the reference).

### Comparative Example 7

Comparative Example 7 was performed in the same manner as the battery of Example 5, except that Negative electrode (1) of Example 1 was replaced with Negative electrode (5) of Comparative Example 1, obtaining Battery (2). Next, the polarization voltage and the polarization voltage difference of Battery (2) were measured, as shown in FIG. 4.

### Comparative Example 8

A lamination (serving as a negative electrode) consisting of a lithium foil and a copper foil (commercially available from Honjo Metal Co., Ltd.) (with a thickness of 60 μm, wherein the thickness of lithium foil was 50 μm), a polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell, wherein the lithium foil of the negative electrode was oriented toward the separator, and the lithium foil of the positive electrode was oriented toward the separator. Next, a liquid electrolyte (with a code of LHCE including lithium bis(fluorosulfonyl)imide (LiFSI) and a solvent (with a concentration of 1.5M), wherein the solvent was 1,2-dimethoxyethane (DME) and 1,1,2,2-tetrafluoroethyl-2,2,3,3-tetrafluoropropyl ether (TTFE)) was injected into the cell. After packaging, Battery (3) was obtained.

Next, the polarization voltage and the polarization voltage difference of Battery (3) were measured, as shown in FIG. 4.

### Comparative Example 9

Comparative Example 9 was performed in the same manner as the battery of Example 5, except that Negative electrode (1) of Example 1 was replaced with Negative electrode (6) of Comparative Example 2, obtaining Battery (4). Next, the polarization voltage and the polarization voltage difference of Battery (4) were measured, as shown in FIG. 4.

FIG. 4 is a graph plotting the polarization voltage against charging/discharging cycle of the batteries of Example 5, Comparative Example 7, Comparative Example 8 and Comparative Example 9. The polarization voltage indicates the influence of interfacial resistance on lithium deposition. A higher polarization voltage suggests higher interfacial resistance associated with lithium deposition. The interfacial resistance includes the resistance of the solid electrolyte interface (SEI) layer and the structural layer. In principle, a smaller SEI layer polarization voltage indicates a lower probability of dendrite formation. However, due to the influence of the structural layer resistance, further confirmation of lithium deposition behavior is needed through the polarization voltage difference. The polarization voltage difference primarily reflects the stacking behavior of lithium deposition. A larger polarization voltage difference indicates perpendicular growth behavior, while a smaller difference indicates horizontal growth behavior, resulting in a more even distribution of planar deposition

As shown in FIG. 4, Battery (1) of Example 5 includes the negative electrode of the disclosure. By means of the protective layer (the protective layer including specific nanopowder (with a specific surface area in a specific range) and specific binder in a specific ratio) disposing on the lithium foil, the deposition condition of lithium metal is changed, thereby reducing the polarization voltage and exhibiting a smoother polarization voltage variation. As a result, lithium is forced to deposit in the horizontal direction, thereby inhibiting the needle-like dendrite growth and volume swelling in the perpendicular direction. Therefore, the performance (such as energy density) of the lithium-ion battery is improved and the cycle life of the lithium-ion battery is extended (i.e. Coulombic efficiency is enhanced). Since the negative electrode used in Comparative Example 8 did not include the protective layer of the disclosure, it leads to a higher battery polarization voltage and a more pronounced variation in polarization voltage.

Although the negative electrodes used in Comparative Examples 7 and 9 included the protective layer, aluminum oxide with low specific surface area served as the nanopowder in the protective layer, resulting in a higher battery polarization voltage and a more pronounced polarization voltage variation.

### Example 6

Negative electrode (1) of Example 1, polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell (wherein the protective layer of the negative electrode was oriented toward the separator, and the lithium foil of the positive electrode was oriented toward the separator). Next, a liquid electrolyte (with a code of LEX including lithium hexafluorophosphate (LiPF₆) and solvent (with a concentration of 1.0M, wherein the solvent was dimethyl carbonate (DMC) and fluoroethylene carbonate (FEC)) was injected into the cell. After packaging, Battery (5) was obtained.

Next, the polarization voltage and the polarization voltage difference of Battery (5) were measured, as shown in FIG. 4. The method for measuring the polarization voltage was disclosed below. The battery was charged and discharged at a fixed current density of 0.5 mAcm⁻². The polarization voltage was the initial voltage during charging. The polarization voltage difference was the percentage difference between the polarization voltage and the intermediate voltage (with the intermediate voltage as the reference).

### Example 7

Negative electrode (4) of Example 4, polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell (wherein the protective layer of the negative electrode was oriented toward the separator, and the lithium foil of the positive electrode was oriented toward the separator). Next, a liquid electrolyte (with a code of LEX including lithium hexafluorophosphate (LiPF₆) and solvent (with a concentration of 1.0M, wherein the solvent was dimethyl carbonate (DMC) and fluoroethylene carbonate (FEC)) was injected into the cell. After packaging, Battery (6) was obtained.

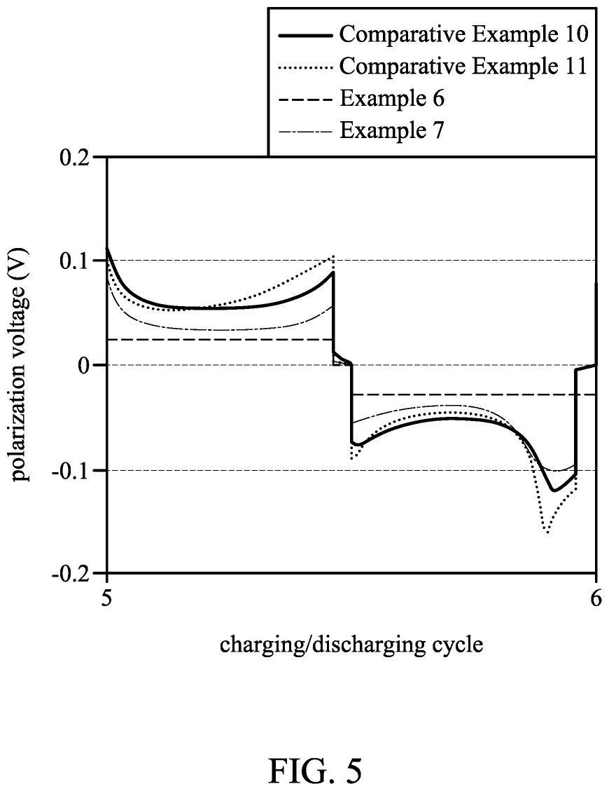

Next, the polarization voltage and the polarization voltage difference of Battery (6) were measured, as shown in FIG. 5. The method for measuring the polarization voltage was disclosed below. The battery was charged and discharged at a fixed current density of 0.5 mAcm⁻². The polarization voltage was the initial voltage during charging. The polarization voltage difference was the percentage difference between the polarization voltage and the intermediate voltage (with the intermediate voltage as the reference).

### Comparative Example 10

A lamination (serving as a negative electrode) consisting of a lithium foil and a copper foil (commercially available from Honjo Metal Co., Ltd.) (with a thickness of 60 μm, wherein the thickness of lithium foil was 50 μm), polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell (wherein the lithium foil of the negative electrode was oriented toward the separator, and the lithium foil of the positive electrode was oriented toward the separator). Next, a liquid electrolyte (with a code of LEX including lithium hexafluorophosphate (LiPF₆) and solvent (with a concentration of 1.0M, wherein the solvent was dimethyl carbonate (DMC) and fluoroethylene carbonate (FEC)) was injected into the cell. After packaging, Battery (7) was obtained.

Next, the polarization voltage and the polarization voltage difference of Battery (7) were measured, as shown in FIG. 5.

### Comparative Example 11

Comparative Example 11 was performed in the same manner as the battery of Example 6, except that Negative electrode (1) of Example 1 was replaced with Negative electrode (7) of Comparative Example 3, obtaining Battery (8). Next, the polarization voltage and the polarization voltage difference of Battery (8) were measured, as shown in FIG. 5.

FIG. 5 is a graph plotting the polarization voltage against charging/discharging cycle of the batteries of Example 6, Example 7, Comparative Example 10, and Comparative Example 11.

As shown in FIG. 5, Battery (5) of Example 6 includes the negative electrode of the disclosure. By means of the protective layer (the protective layer including specific nanopowder (with a specific surface area in a specific range) and specific binder in a specific ratio)) disposing on the lithium foil, the deposition condition of lithium metal is changed, thereby reducing the polarization voltage and exhibiting a smoother polarization voltage variation. As a result, lithium is forced to deposit in the horizontal direction, thereby inhibiting the needle-like dendrite growth and volume swelling in the perpendicular direction. Therefore, the performance (such as energy density) of the lithium-ion battery is improved and the cycle life of the lithium-ion battery is extended (i.e. Coulombic efficiency is enhanced). When replacing aluminum oxide with aluminum nitride to serve as the nanopowder of the protective layer, the obtained battery (i.e. Battery (6) of Example 7) exhibited reduced polarization voltage. Since the negative electrode used in Comparative Example 10 did not include the protective layer of the disclosure, it leads to a higher battery polarization voltage and a more pronounced variation in polarization voltage. Although the negative electrodes used in Comparative Example 11 included the protective layer, aluminum oxide with low specific surface area served as the nanopowder in the protective layer, resulting in a higher battery polarization voltage and a more pronounced polarization voltage variation.

### Comparative Example 12

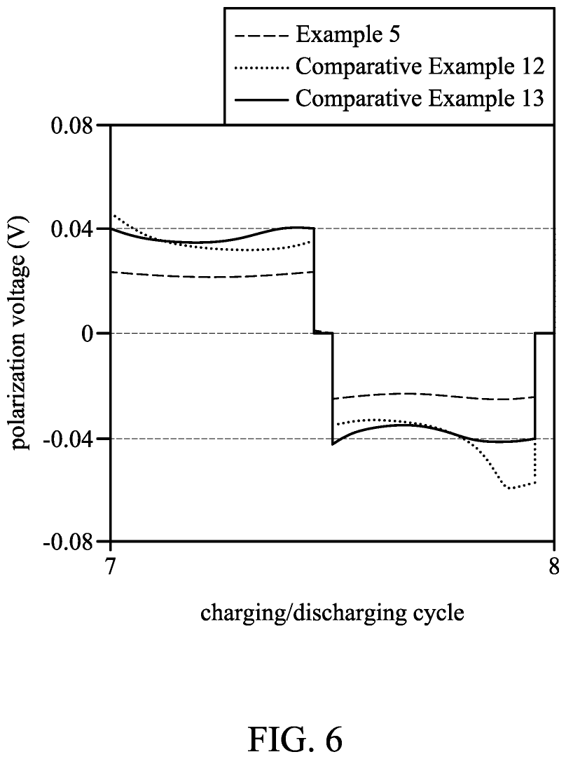

Comparative Example 12 was performed in the same manner as the battery of Example 5, except that Negative electrode (1) of Example 1 was replaced with Negative electrode (8) of Comparative Example 4, obtaining Battery (9). Next, the polarization voltage and the polarization voltage difference of Battery (9) were measured, as shown in FIG. 6.

### Comparative Example 13

Comparative Example 13 was performed in the same manner as the battery of Example 5, except that Negative electrode (1) of Example 1 was replaced with Negative electrode (9) of Comparative Example 5, obtaining Battery (10). Next, the polarization voltage and the polarization voltage difference of Battery (10) were measured, as shown in FIG. 6.

FIG. 6 is a graph plotting the polarization voltage against charging/discharging cycle of the batteries of Example 5, Comparative Example 12, and Comparative Example 13. As shown in FIG. 6, since lithium zirconium phosphate was used serving as the nanopowder in the negative electrode in Comparative Example 12, it leads to a higher battery polarization voltage and a more pronounced variation in polarization voltage. In addition, since lithium lanthanum zirconate was used serving as the nanopowder in the negative electrode in Comparative Example 13, resulting in a higher battery polarization voltage and a more pronounced polarization voltage variation.

### Example 8

Negative electrode (1) of Example 1, polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell (wherein the protective layer of the negative electrode was oriented toward the separator, and the lithium foil of the positive electrode was oriented toward the separator). Next, a liquid electrolyte (with a code of NDFX including lithium tetrafluoroborate (LiBF₄) and solvent (with a concentration of 1.5M), wherein the solvent was fluoroethylene carbonate (FEC) and diethyl carbonate (DEC)) was injected into the cell. After packaging, Battery (11) was obtained.

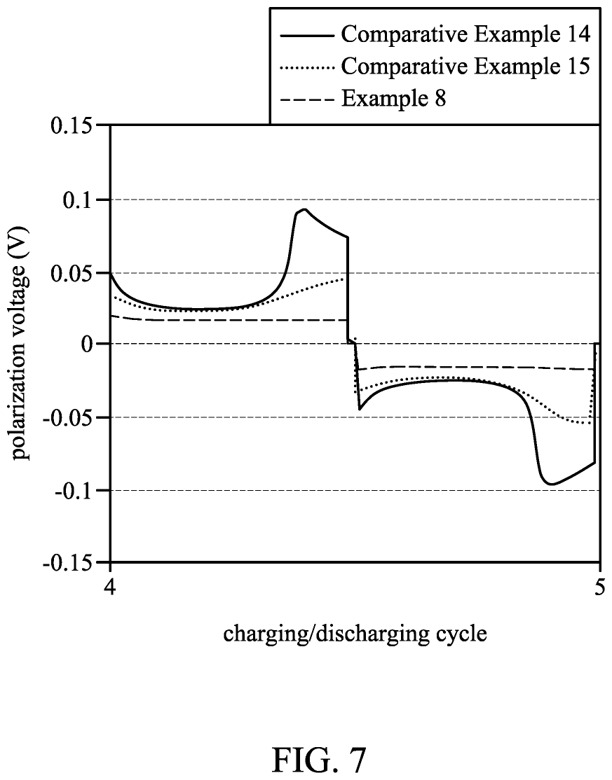

Next, the polarization voltage and the polarization voltage difference of Battery (11) were measured, as shown in FIG. 7. The method for measuring the polarization voltage was disclosed below. The battery was charged and discharged at a fixed current density of 0.5 mAcm⁻², wherein the polarization voltage was the initial voltage during charging in the cycle. The polarization voltage was the initial voltage during charging. The polarization voltage difference was the percentage difference between the polarization voltage and the intermediate voltage (with the intermediate voltage as the reference).

### Comparative Example 14

A lamination (serving as a negative electrode) consisting of a lithium foil and a copper foil (commercially available from Honjo Metal Co., Ltd.) (with a thickness of 60 μm, wherein the thickness of lithium foil was 50 μm), polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, the negative electrode, separator and the positive electrode were placed in sequence and sealed within a cell (wherein the lithium foil of the negative electrode was oriented toward the separator, and the lithium foil of the positive electrode was oriented toward the separator). Next, a liquid electrolyte (with a code of NDFX including lithium tetrafluoroborate (LiBF₄) and solvent (with a concentration of 1.5M, wherein the solvent was fluoroethylene carbonate (FEC) and diethyl carbonate (DEC)) was injected into the cell. After packaging, Battery (12) was obtained.

Next, the polarization voltage and the polarization voltage difference of Battery (12) were measured, as shown in FIG. 7.

### Comparative Example 15

Comparative Example 15 was performed in the same manner as the battery of Example 8, except that Negative electrode (1) of Example 1 was replaced with Negative electrode (10) of Comparative Example 6, obtaining Battery (13). Next, the polarization voltage and the polarization voltage difference of Battery (13) were measured, as shown in FIG. 7.

FIG. 7 is a graph plotting the polarization voltage against charging/discharging cycle of the batteries of Example 8, Comparative Example 14 and Comparative Example 15. As shown in FIG. 7, Battery (11) of Example 8 includes the negative electrode of the disclosure. By means of the protective layer (the protective layer including specific nanopowder (with a specific surface area in a specific range) and specific binder in a specific ratio)) disposing on the lithium foil, the deposition condition of lithium metal is changed, thereby reducing the polarization voltage and exhibiting a smoother polarization voltage variation. As a result, lithium is forced to deposit in the horizontal direction, thereby inhibiting the needle-like dendrite growth and volume swelling in the perpendicular direction. Therefore, the performance (such as energy density) of the lithium-ion battery is improved and the cycle life of the lithium-ion battery is extended (i.e. Coulombic efficiency is enhanced). Since the negative electrode used in Comparative Example 14 did not include the protective layer of the disclosure, it leads to a higher battery polarization voltage and a more pronounced variation in polarization voltage. Although the negative electrode used in Comparative Examples 15 included the protective layer and the nanopowder in the protective layer had a specific surface area within the range of the disclosure, the negative electrode of Comparative Example 15 employed the conductive carbon black as nanopowder. The conductive carbon black does not possess the function of a protective layer, resulting in a higher battery polarization voltage and a more pronounced polarization voltage variation.

### Comparative Example 16

A lamination (serving as a negative electrode) consisting of a lithium foil and a copper foil (commercially available from Honjo Metal Co., Ltd.) (with a thickness of 60 μm, wherein the thickness of lithium foil was 50 μm), polypropylene (PP) separator (with a trade number of 2320, commercially available from Celgard, thickness about 20 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Next, γ-aluminum oxide nanopowder (1) (with a mean primary particle size of about 10 nm and a specific surface area of about 115 m²/g) was dispersed in a liquid electrolyte (with a code of LHCE including lithium bis(fluorosulfonyl)imide (LiFSI) and solvent (with a concentration of 1.5M), wherein the solvent was 1,2-dimethoxyethane (DME) and 1,1,2,2-tetrafluoroethyl-2,2,3,3-tetrafluoropropyl ether (TTFE)) and the weight ratio of γ-aluminum oxide nanopowder (1) to liquid electrolyte was 3:97, obtaining a suspension.

Next, the negative electrode, separator and the positive electrode were placed in sequence and sealed within a cell (wherein the lithium foil of the negative electrode was oriented toward the separator, and the lithium foil of the positive electrode was oriented toward the separator). Next, the suspension was injected into the cell. After packaging, Battery (14) was obtained.

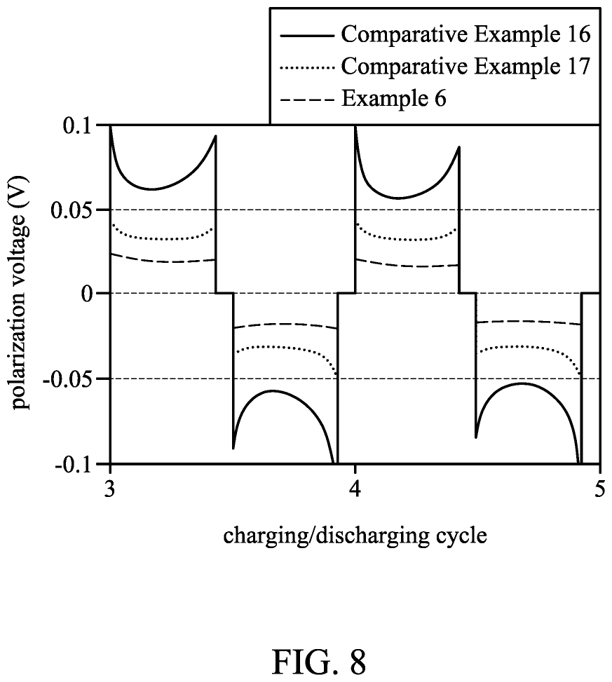

Next, the polarization voltage and the polarization voltage difference of Battery (14) were measured, as shown in FIG. 8.

### Comparative Example 17

A lamination (serving as a negative electrode) consisting of a lithium foil and a copper foil (commercially available from Honjo Metal Co., Ltd.) (with a thickness of 60 μm, wherein the thickness of lithium foil was 50 μm), and a lamination (serving as a positive electrode) consisting of a lithium foil and a copper foil (commercially available from Honjo Metal Co., Ltd.) (with a thickness of 60 μm, wherein the thickness of lithium foil was 50 μm) were provided.

Protective layer slurry (1) of Example 1 and polypropylene (PP) separator (with a trade number of 2320, commercially available from Celgard, thickness about 20 μm) were provided. Next, the protective layer slurry (1) was coated onto the polypropylene (PP) separator by blade coating. After drying at 80° C., a polypropylene (PP) separator with a protective layer (with a thickness of about 5 μm) was obtained.

Next, the negative electrode, separator and the positive electrode were placed in sequence and sealed within a cell (wherein the lithium foil of the negative electrode was oriented toward the separator, the protective layer of the separator was oriented toward the negative electrode, and the lithium foil of the positive electrode was oriented toward the separator). Next, a liquid electrolyte (with a code of LHCE including lithium bis(fluorosulfonyl)imide (LiFSI) and solvent (with a concentration of 1.5M), wherein the solvent was 1,2-dimethoxyethane (DME) and 1,1,2,2-tetrafluoroethyl-2,2,3,3-tetrafluoropropyl ether (TTFE)) was injected into the cell. After packaging, Battery (15) was obtained.

Next, the polarization voltage and the polarization voltage difference of Battery (15) were measured, as shown in FIG. 8.

FIG. 8 is a graph plotting the polarization voltage against charging/discharging cycle of the batteries of Example 6, Comparative Example 16, and Comparative Example 17. As shown in FIG. 8, even when the nanopowder of the disclosure was added to the liquid electrolyte, it is still unable to reduce the polarization voltage of the battery (Comparative Example 16), and the polarization voltage exhibited significant fluctuations. In additional, when the protective layer of the disclosure was formed on the separator instead of on the negative electrode active layer, it is unable to reduce the polarization voltage of the resulting battery (Comparative Example 17), and the polarization voltage variation was more severe.

### Preparation and Performance Evaluation of Lithium Battery

### Example 9

96 parts by weight lithium nickel manganese cobalt oxide (with a structure of LiNi_{0.6}Mn_{0.2}Co_{0.2}O₂, with a trade number of NMC622, commercially available from Ningbo Ronbay New Energy Technology Co., Ltd.), 2 parts by weight conductive carbon black (with a trade number of Super-P, commercially available from Timcal), and 2 parts by weight polyvinylidene fluoride (PVDF) binder (with a trade number of PVDF-5130, commercially available from Solvay) were uniformly dispersed in N-methylpyrrolidinone (NMP), obtaining a positive electrode active layer slurry. Next, the positive electrode active layer slurry was coated on an aluminum foil (serving as positive electrode current-collecting layer) (commercially available from UACJ, with a thickness of 12 μm). After drying, a positive electrode active layer (disposed on the positive electrode current-collecting layer) (with an area weight about 19 mg/cm²) was obtained, wherein the lamination of the positive electrode current-collecting layer and the positive electrode active layer served as the positive electrode.

Negative electrode (1) of Example 1 and polypropylene (PP) separator (with a trade number of 2320, commercially available from Celgard, thickness about 20 μm) were provided.

Next, the negative electrode, separator and the positive electrode were placed in sequence and sealed within a cell (wherein the protective layer of the negative electrode was oriented toward the separator, and the positive electrode active layer of the positive electrode was oriented toward the separator). Next, a liquid electrolyte (with a code of LHCE including lithium bis(fluorosulfonyl)imide (LiFSI) and solvent (with a concentration of 1.5M), wherein the solvent was 1,2-dimethoxyethane (DME) and 1,1,2,2-tetrafluoroethyl-2,2,3,3-tetrafluoropropyl ether (TTFE)) was injected into the cell. After packaging, Battery (16) was obtained.

Next, Battery (16) was subjected to a charging/discharging cycle test at charging/discharging rate of 0.2C/0.5C, and the number of the charging/discharging cycle was determined when the discharging capacity of Battery (16) was lower than 80%. The result is shown in Table 3.

### Comparative Example 18

A lamination (serving as a negative electrode) consisting of a lithium foil and a copper foil (commercially available from Honjo Metal Co., Ltd.) (with a thickness of 60 μm, wherein the thickness of lithium foil was 50 μm), polypropylene (PP) separator (with a trade number of 2320, commercially available from Celgard, thickness about 20 μm), and the positive electrode of Example 9 were provided.

Next, the negative electrode, separator and the positive electrode were placed in sequence and sealed within a cell (wherein the lithium foil of the negative electrode was oriented toward the separator, and the positive electrode active layer of the positive electrode was oriented toward the separator). Next, a liquid electrolyte (with a code of LHCE including lithium bis(fluorosulfonyl)imide (LiFSI) and solvent (with a concentration of 1.5M), wherein the solvent was 1,2-dimethoxyethane (DME) and 1,1,2,2-tetrafluoroethyl-2,2,3,3-tetrafluoropropyl ether (TTFE)) was injected into the cell. After packaging, Battery (17) was obtained.

Next, Battery (17) was subjected to a charging/discharging cycle test at charging/discharging rate of 0.2C/0.5C, and the number of the charging/discharging cycle was determined when the discharging capacity of Battery (17) was lower than 80%. The result is shown in Table 3.

TABLE 3

| | the number of |
|---|---|
| | the charging/discharging |
| | cycles when the discharging |
| | capacity lower than 80% |
| Example 9 | >218 |
| Comparative Example 18 | 162 |

As shown in Table 3, in comparison with Comparative Example 18, Battery (16) of Example 9 included the negative electrode of the disclosure. By means of the protective layer (the protective layer including specific nanopowder (with a specific surface area in a specific range) and specific binder in a specific ratio)) disposing on the lithium foil, the deposition condition of lithium metal is changed, thereby extending the cycle life of the lithium-ion battery.

### Example 10

The positive electrode of Example 9, Negative electrode (1) of Example 1, and polypropylene (PP) separator (with a trade number of 2320, commercially available from Celgard, thickness about 20 μm) were provided.

Next, the negative electrode, separator and the positive electrode were placed in sequence and sealed within a cell (wherein the protective layer of the negative electrode was oriented toward the separator, and the positive electrode active layer of the positive electrode was oriented toward the separator). Next, a liquid electrolyte (with a code of LEX including lithium hexafluorophosphate (LiPF₆) and solvent (with a concentration of 1.0M), wherein the solvent was dimethyl carbonate (DMC) and fluoroethylene carbonate (FEC)) was injected into the cell. After packaging, Battery (18) was obtained.

Next, Battery (18) was subjected to a charging/discharging cycle test at charging/discharging rate of 0.2C/0.5C, and the number of the charging/discharging cycle was determined when the discharging capacity of Battery (18) was lower than 80%. The result is shown in Table 4.

### Comparative Example 19

A lamination (serving as a negative electrode) consisting of a lithium foil and a copper foil (commercially available from Honjo Metal Co., Ltd.) (with a thickness of 60 μm, wherein the thickness of lithium foil was 50 μm), polypropylene (PP) separator (with a trade number of 2320, commercially available from Celgard, thickness about 20 μm), and the positive electrode of Example 9 were provided.

Next, the negative electrode, separator and the positive electrode were placed in sequence and sealed within a cell (wherein the lithium foil of the negative electrode was oriented toward the separator, and the positive electrode active layer of the positive electrode was oriented toward the separator). Next, a liquid electrolyte (with a code of LEX including lithium hexafluorophosphate (LiPF₆) and solvent (with a concentration of 1.0M, wherein the solvent was dimethyl carbonate (DMC) and fluoroethylene carbonate (FEC)) was injected into the cell. After packaging, Battery (19) was obtained.

Next, Battery (19) was subjected to a charging/discharging cycle test at charging/discharging rate of 0.2C/0.5C, and the number of the charging/discharging cycle was determined when the discharging capacity of Battery (19) was lower than 80%. The result is shown in Table 4.

TABLE 4

| | the number of |
|---|---|
| | the charging/discharging |
| | cycles when the discharging |
| | capacity lower than 80% |
| Example 10 | 186 |
| Comparative Example 19 | 157 |

As shown in Table 4, in comparison with Comparative Example 19, Battery (18) of Example 10 included the negative electrode of the disclosure. By means of the protective layer (the protective layer including specific nanopowder (with a specific surface area in a specific range) and specific binder in a specific ratio)) disposing on the lithium foil, the deposition condition of lithium metal is changed, thereby extending the cycle life of the lithium-ion battery.

### Example 11

The positive electrode of Example 9, Negative electrode (1) of Example 1, and polypropylene (PP) separator (with a trade number of 2320, commercially available from Celgard, thickness about 20 μm) were provided.

Next, the negative electrode, separator and the positive electrode were placed in sequence and sealed within a cell (wherein the protective layer of the negative electrode was oriented toward the separator, and the positive electrode active layer of the positive electrode was oriented toward the separator). Next, a liquid electrolyte (with a code of NDFX including lithium tetrafluoroborate (LiBF₄) and solvent (with a concentration of 1.5M), wherein the solvent was fluoroethylene carbonate (FEC) and diethyl carbonate(diethyl carbonate, DEC)) was injected into the cell. After packaging, Battery (20) was obtained.

Next, Battery (20) was subjected to a charging/discharging cycle test at charging/discharging rate of 0.1C/0.25C, and the number of the charging/discharging cycle was determined when the discharging capacity of Battery (20) was lower than 80%. The result is shown in Table 5.

### Example 12

Example 12 was performed in the same manner as the battery of Example 11, except that Negative electrode (1) of Example 1 was replaced with Negative electrode (2) of Example 2, obtaining Battery (21). Next, Battery (21) was subjected to a charging/discharging cycle test at charging/discharging rate of 0.1C/0.25C, and the number of the charging/discharging cycle was determined when the discharging capacity of Battery (21) was lower than 80%. The result is shown in Table 5.

### Example 13

Example 13 was performed in the same manner as the battery of Example 11, except that Negative electrode (1) of Example 1 was replaced with Negative electrode (3) of Example 3, obtaining Battery (22). Next, Battery (22) was subjected to a charging/discharging cycle test at charging/discharging rate of 0.1C/0.25C, and the number of the charging/discharging cycle was determined when the discharging capacity of Battery (22) was lower than 80%. The result is shown in Table 5.

### Comparative Example 20

A lamination (serving as a negative electrode) consisting of a lithium foil and a copper foil (commercially available from Honjo Metal Co., Ltd.) (with a thickness of 60 μm, wherein the thickness of lithium foil was 50 μm), polypropylene (PP) separator (with a trade number of 2320, commercially available from Celgard, thickness about 20 μm), and the positive electrode of Example 9 were provided.

Next, the negative electrode, separator and the positive electrode were placed in sequence and sealed within a cell (wherein the lithium foil of the negative electrode was oriented toward the separator, and the positive electrode active layer of the positive electrode was oriented toward the separator). Next, a liquid electrolyte (with a code of NDFX including lithium tetrafluoroborate (LiBF₄) and solvent (with a concentration of 1.5M), wherein the solvent was fluoroethylene carbonate (FEC) and diethyl carbonate (DEC)) was injected into the cell. After packaging, Battery (23) was obtained.

Next, Battery (23) was subjected to a charging/discharging cycle test at charging/discharging rate of 0.1C/0.25C, and the number of the charging/discharging cycle was determined when the discharging capacity of Battery (23) was lower than 80%. The result is shown in Table 5. For convenience of comparison, Table 5 is presented in terms of cycle number relative values, with the number of the charging/discharging cycle of the battery in Comparative Example 20 lower than 80% used as the reference point (defined as 100%).

TABLE 5

| | the percentage of the |
|---|---|
| | charging/discharging cycles when the |
| | discharging capacity lower than 80% |
| | (%) |
| Example 11 | 140 |
| Example 12 | 113 |
| Example 13 | 108 |
| Comparative Example 20 | 100 |

As shown in Table 5, in comparison with the Comparative Example 20, since the negative electrodes of the batteries of Examples 11-13 employed the protective layer of the disclosure disposed on the negative electrode active layer, thereby increasing the cycle life of lithium-ion battery.

According to embodiments of the disclosure, the negative electrode of the disclosure includes a negative electrode active layer and a protective layer, wherein the protective layer can include a specific nanopowder and a specific binder. By means of the specific ratio of nanopowder to binder, a uniform ion diffusion pathway can be constructed during the charging/discharging process, thereby achieving the purpose of enhancing the uniformity of ion concentration and increasing interfacial energy. Due to the protective layer made from the nanopowder having high specific surface area and the specific binder, the surface smoothness of the negative electrode during the charging/discharging process can be enhanced and the formation of metal dendrites can be mitigated and inhibited, thereby improving the performance and extending the cycle life of the battery.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A negative electrode, comprising:
a negative electrode active layer; and
a protective layer disposed on the negative electrode active layer, wherein the protective layer comprises a nanopowder and a binder, wherein the nanopowder has a specific surface area of 30 m²/g to 1,000 m²/g; the nanopowder has a binding energy less than or equal to −2.5 eV; the weight ratio of the nanopowder to the binder is from 51:49 to 99:1; and, the nanopowder is a compound having a structure represented by Formula (I)
MᵢXⱼ Formula (I)
wherein M is aluminum, magnesium, zirconium, zinc, or silicon; X is O or N;
i is 1, 2 or 3; j is 1, 2, 3, or 4.

2. The negative electrode as claimed in claim 1, wherein the binder is fluorine-containing polymer, wherein the fluorine-containing polymer is polytetrafluoroethylene (PTFE), polyvinylidene fluoride (PVDF), perfluoroalkoxy alkane (PFA), fluorinated ethylene propylene (FEP), polyvinylidene fluoride-co-hexafluoropropen (PVDF-HFP), polyvinylene fluoride (PVF), or a combination thereof.

3. The negative electrode as claimed in claim 1, wherein the nanopowder is aluminum oxide, magnesium oxide, zirconium oxide, zinc oxide, silicon oxide, aluminum nitride, magnesium nitride, zirconium nitride, zinc nitride, silicon nitride, or a combination thereof.

4. The negative electrode as claimed in claim 1, wherein the thickness of the protective layer is 0.01 μm to 10 μm.

5. The negative electrode as claimed in claim 1, wherein the negative electrode active layer comprises a negative electrode active material, wherein the negative electrode active material is lithium metal, lithium metal alloy, or a combination thereof.

6. The negative electrode as claimed in claim 5, wherein the negative electrode active layer further comprises a binder, wherein the binder is polytetrafluoroethylene (PTFE), polyvinylidene fluoride (PVDF), poly(styrene-co-butadiene), fluorine rubber, polyurethane, polyvinylpyrrolidone, polyvinyl carbonate, polyvinyl chloride (PVC), polyacrylonitrile (PAN), polybutadiene, poly(acrylic acid) (PAA), or a combination thereof.

7. The negative electrode as claimed in claim 1, further comprising:
a negative electrode current-collecting layer, wherein the negative electrode active layer is disposed on the negative electrode current-collecting layer.

8. The negative electrode as claimed in claim 1, wherein the nanopowder has a mean primary particle size of 1 nm to 300 nm.

9. A battery, comprising:
a negative electrode, wherein the negative electrode is the negative electrode as claimed in claim 1;
a separator; and
a positive electrode, wherein the negative electrode is separated from the positive electrode via the separator.

10. The battery as claimed in claim 9, further comprising:
a liquid electrolyte disposed between the positive electrode and the negative electrode.

11. The battery as claimed in claim 9, wherein the positive electrode comprises a positive electrode active layer.

12. The battery as claimed in claim 11, wherein the positive electrode active layer comprises a positive electrode active material, wherein the positive electrode active material is sulfur, organic sulfide, sulfur-carbon composite, metal-containing lithium oxide, metal-containing lithium sulfide, metal-containing lithium selenide, metal-containing lithium telluride, metal-containing lithium silicide, metal-containing lithium boride, or a combination thereof, wherein the metal is selected from a group consisting of aluminum, vanadium, titanium, chromium, copper, molybdenum, niobium, iron, nickel, cobalt and manganese.

13. The battery as claimed in claim 11, wherein the positive electrode active layer further comprises a binder, wherein the binder is polyvinyl alcohol (PVA), polytetrafluoroethylene (PTFE), carboxymethyl cellulose (CMC) sodium, polyvinylidene fluoride (PVDF), poly(styrene-co-butadiene), fluorine rubber, polyurethane, polyvinylpyrrolidone, polyvinyl carbonate, polyvinyl chloride (PVC), polyacrylonitrile (PAN), polybutadiene, poly(acrylic acid) (PAA), or a combination thereof.

14. The battery as claimed in claim 11, wherein the positive electrode further comprises a positive electrode current-collecting layer, wherein the positive electrode active layer is disposed on the positive electrode current-collecting layer.
